(19) United States
(12) Patent Application Publication
(10) Pub. No.: US 2014/0289593 A1
(43) Pub. Date: Sep. 25, 2014

(54) Apparatus & Method for Reviewing a Written Work Using an Electronic Display

(71) Applicants: Basker S. Krishnan, San Marino, CA (US); Hanoz J. Kateli, Monrovia, CA (US); Bryan Heesch, Pasadena, CA (US)

(72) Inventors: Basker S. Krishnan, San Marino, CA (US); Hanoz J. Kateli, Monrovia, CA (US); Bryan Heesch, Pasadena, CA (US)

(21) Appl. No.: 14/189,974

(22) Filed: Feb. 25, 2014

Related U.S. Application Data
(60) Provisional application No. 61/770,783, filed on Feb. 28, 2013.

(51) Int. Cl. G06F 17/21

(52) U.S. Cl. CPC G06F 17/211
USPC 715/201

(57) ABSTRACT

An apparatus and method for displaying a written work on an electronic display including using the electronic display to select a written work from a database; presenting the written work on a first screen of the electronic display in a three dimensional view; and using the electronic display to turn at least one page of the written work.

### CLAIM OF PRIORITY UNDER 35 U.S.C. §119

The present Application for Patent claims priority to Provisional Application No. 61/770,783 entitled “Apparatus and Method for Reviewing a Bound Written Work Using Electronic Display” filed Feb. 28, 2013, and assigned to the assignee hereof and hereby expressly incorporated by reference herein.

### FIELD

This disclosure relates generally to apparatus and methods for electronic display. More particularly, the disclosure relates to reviewing a written work using an electronic display.

### BACKGROUND

Hardcopy paper reading materials are becoming less favored as readers are transitioning to reading on electronic tablets or pads (i.e., electronic display). Current electronic display of a written work (including a bound written work) is in two dimensions, where the context of the written work is displayed in a planar fashion. For example, sequential pages are presented to the reader in a scrolling fashion where the reader scrolls the first page to the last page in a vertical fashion (e.g., top to bottom of the electronic display screen) or in a horizontal fashion (e.g., left to right or right to left of the electronic display screen). Thus, the reader's feeling and experience of reading a physically written work (such as, but not limited to, a bound book) is lost.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Disclosed is an apparatus and method for reviewing a written work using an electronic display. According to one aspect, an electronic display including a left edge and a right edge; a first screen situated between the left edge and the right edge, the first screen for presenting a written work in a three dimensional view; a first sensor embedded on the left edge, and a second sensor embedded on the right edge, wherein the first sensor is for turning electronic pages of the written work towards the left edge and the second sensor is for turning electronic pages of the written work towards the right edge.

According to another aspect, a method of displaying a written work on an electronic display including using the electronic display to select a written work from a database; presenting the written work on a first screen of the electronic display in a three dimensional view; and using the electronic display to turn at least one page of the written work.

Advantages of the present disclosure may include retaining the experience of reading a hardcopy paper written work through the use of an electronic display; for example, retaining the ability to flip through pages while browsing, turn the written work towards one side or upside down and having the view of the pages of the written work turn towards one side or upside down, respectively, etc. The features, nature, and advantages of the present disclosure listed herein are not exclusive and more advantages may become apparent from the detailed description set forth below when taken in conjunction with the drawings.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example of an electronic display including a screen, wherein the screen is presenting a 3D view of a book.

FIG. 2 illustrates the example of the electronic display of FIG. 1 turned 90 degrees to the left.

FIG. 3 illustrates an example listing the parts of a bounded written work.

FIG. 4 illustrates an example of a single page of a written work being dog eared.

FIG. 5 illustrates an example of a 2-page view of a written work being dog eared.

FIG. 6 illustrates an example of an electronic display with a hinge.

FIG. 7 illustrates an example of a written work with thumb index.

FIG. 8 illustrates an example of a flow diagram for displaying a written work on an electronic display.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

In the present disclosure, a reader's (e.g., reviewer, user, etc.) experience of reading (e.g., reviewing, browsing, flipping through pages, etc.) a written work is replicated through the use of an electronic display to review the written work. Examples of an electronic display may include: eBook, iBook readers, Kindle, iPad, iPhone, eReaders, mobile hand held devices, laptops, personal computers (PC), Mac (Apple) computers. Some examples of written work may include bound written work, books, magazines, and printed and digital material, etc. which can be made to mimic printed versions. One skilled in the art would understand that the examples listed herein are not exhaustive. In accordance with the present disclosure, usage of an electronic display to review the written work may include one or more of the following steps illustrated herein. One skilled in the art would understand that the steps illustrated herein are not exclusive or restrictive.

In one aspect, a written work is selected from a database containing at least one written work. For example, the database may be an electronic storage of written works (e.g., a library of written works). In one example, the database may display all or some of its written work in three dimensional view (3D) with the view of the front cover of each written work. Or, the database display of its contents may be a list or text summary of all or some of the written work in the database. In one example, once a written work is selected (e.g., by a reader), the selected written work is displayed in a three dimensional view (3D) with the view of its front cover. One skilled in the art would understand that although it is herein disclosed that the front cover of a written work is displayed, other choices of viewing the written work may be used (for example, a picture or logo of the author, a representative artwork of the written work, a sample page of the written work, a text phrase associated with the written work, etc.) and are also within the scope and spirit of the present disclosure.

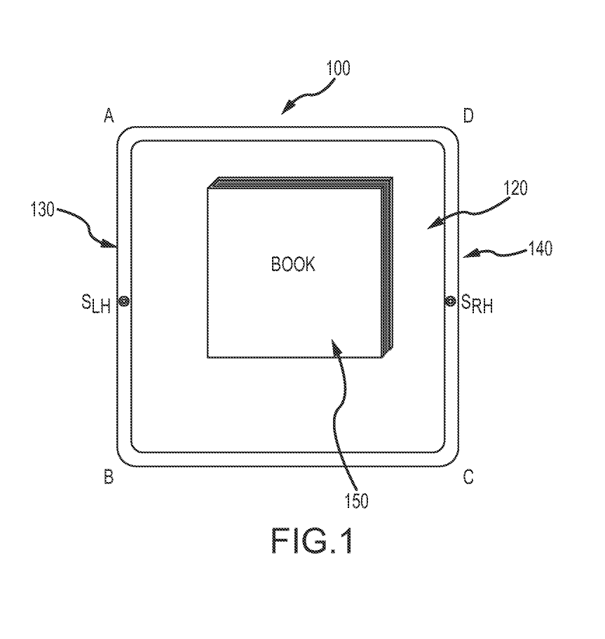

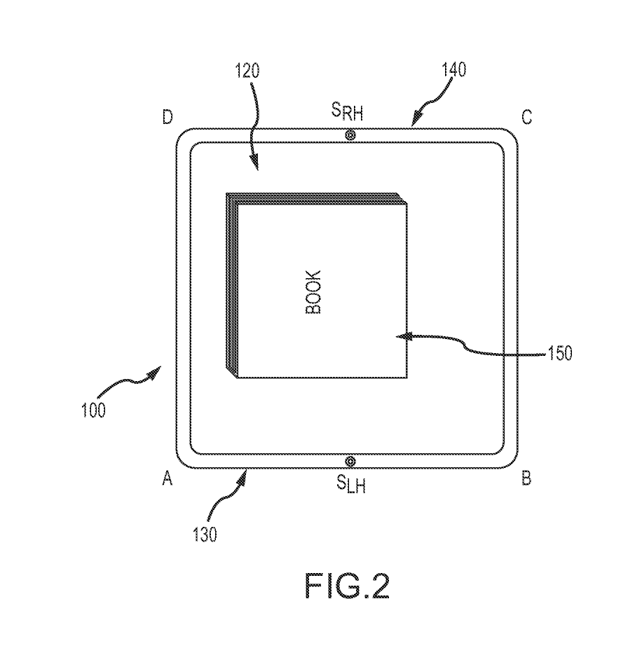

In one aspect, the written work may be viewed from angles other than a front view of the front cover. For example, as the reader changes the electronic display's orientation around any axis, the orientation change of the electronic display will also respectively change the 3D view of the written work. This particular feature differs from conventional electronic tablets or pads wherein any orientation change on the conventional electronic tablets or pads will force a compensation so that what is being displayed is not affected. In the present disclosure, angular rotation (i.e., changing the electronic display's orientation) respectively changes the view of the written work being displayed. For example, if the electronic display is turned 90 degrees to the right, than the view of the written work being displayed is also turned 90 degrees to the right. FIG. 1 illustrates an example of an electronic display 100 including a screen 120, wherein the screen 120 is presenting a 3D view of a written work 150 (e.g. book). The four corners of the electronic display 100 are marked as “A”, “B”, “C” and “D” with “A” on the upper left, “B” on the lower left, “C” on the lower right and “D” on the upper right. FIG. 2 illustrates the example of the electronic display 100 of FIG. 1 turned 90 degrees to the left. The four corners (marked as A, B, C and D) of the electronic display 100 are now “D” on the upper left, “A” on the lower left, “B” on the lower right and “C” on the upper right. The 3D view of the written work 150 (e.g., book) is respectively turned 90 degrees to the left as illustrated in FIG. 2. Although the view of the written work 150 is disclosed herein as in a three dimensional view (3D), one skilled in the art would understand that other views, such as a two dimensional view (2D), may also be presented without affecting the scope and spirit of the present disclosure.

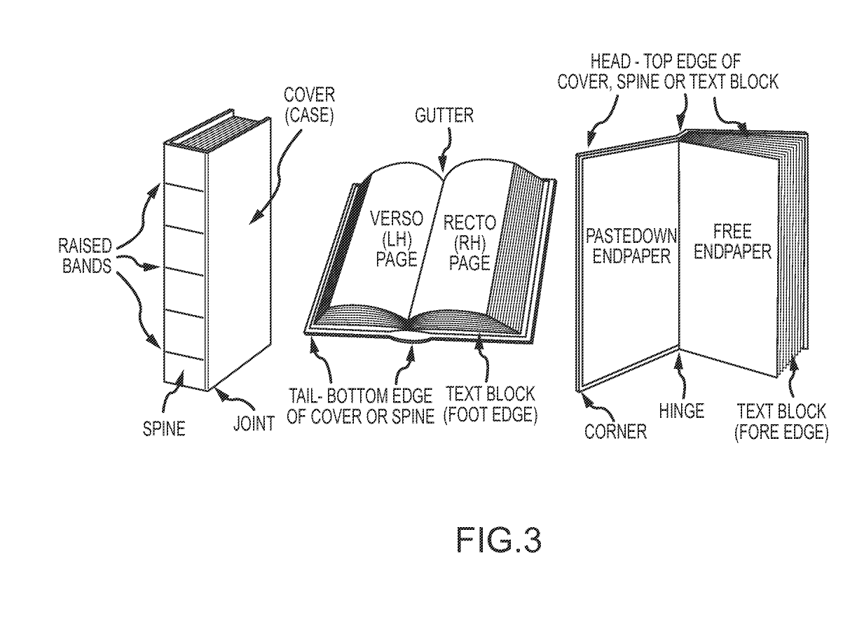

FIG. 3 illustrates an example listing the parts of a bounded written work. In one example, the bounded written work is a book. For example, the various parts of the bounded written work include raised bands, cover (case), spine, joint, verso (LD) page, recto (RH) page, gutter, tail-bottom edge of cover or spine, text block (foot edge), head—top edge of cover, spine or text block, pastedown endpaper, free endpaper, corner, hinge and text block (fore edge). In one example, just as with a hardcopy book (i.e., a physical book), by changing the orientation of the electronic display 100, the screen 120 may present the fore edge, top edge or foot edge text blocks or the spine of the written work 150 (e.g., book), depending on the change of the orientation of the electronic display 100.

In one aspect, the reader may open the written work being presented on the screen 120 of the electronic display 100 by performing one or more of the following: by tapping on the front cover of the written work that is presented on the screen, by clicking a sensor on the electronic display (e.g., a single clicking on a sensor located at the edge of the electronic display), and/or by applying a slight pressure on a sensor on the electronic display (e.g., applying a slight pressure on top of the sensor located on the edge of the electronic display). In one example, the reader holds a thumb within the fore edge text block location of the written work as presented on the screen 120, and combined with a short quick flip, this action will open the written work presented on the screen 120 to the approximate desired page location.

In one aspect, the screen 120 includes a reading display mode which allows a 2-page view of the written work 150. The 2-page view may be presented when the electronic display 100 is held in a landscape position or in a portrait position. In one example, a single page view may also be selected whether the electronic display 100 is held in landscape position or in portrait position. In one example, when the electronic display 100 is held in portrait position, the default is a single page view, whereas when the electronic display 100 is held in landscape position, the default is a 2-page view. In one example, with the electronic display 100 in the portrait position, the screen 120 may present the single page view of the verso left hand (LH) page, just as with holding a physical book in the reader's hand. In another example, the single page view may be that of the recto right hand (RH) page.

In the example of the single page view of the verso (LH) page, the retro right hand (RH) page may also be presented in a small portion of the screen 120 with page curvature as with an open physical book. The gutter may or may not be visible based on the thickness of a physical book and the orientation of the electronic display 100. Similarly, if the single page view is of the recto (RH) page, the verso (LH) page may also be presented in a small portion of the screen 120 with page curvature as with an open physical book.

In one example, as the electronic display 100 is rotated from portrait position to landscape position, the screen 120 display changes from the single page view to the 2 page view. Similarly, as the electronic display 100 is rotated from landscape position to portrait position, the screen 120 display changes from the 2-page view to the single page view. In another aspect, whether the electronic display 100 is in landscape position or portrait position, multi-page view of the written work 150 may be presented on the screen 120.

In one aspect, the electronic display 100 may recreate and display the natural curvature of the pages with the gutter and the text blocks on either side of the verso and recto pages. And, portions of the foot edge or top edge of the text blocks of the written work 150 may be visible based on the orientation of the electronic display 100 being held.

In one aspect, the electronic display 100 may replicate the movements of a physical book in the reader's hands. Movements of the electronic display 100 may change the perspective and orientation of the written work's view (e.g., 3D view) as presented on the screen 120 just as would be the case if the reader were holding a physical book in his hand.

In one aspect, the electronic display 100 includes a left sensor on its left edge and a right sensor on its right edge. As an example, the left sensor is illustrated as S_{LH} and the right sensor is illustrated as S_{RH} in FIG. 1. The reader may use the thumb to turn or flip a page of the written work 150 presented on the screen 120 by a single click. In one example, a slight tap of the right sensor turns the recto (RH) page to its next page and a slight tap of the left sensor turns the verso (LH) page to its previous page. Minor page turning may be accomplished by pressing the sensor (S_{LH} or S_{RH}) on either side of the device or on the edge of the page display on the screen with the thumb on either hand. Continued pressing of the sensor (S_{LH} or S_{RH}) will flip the pages at a faster rate.

In one example, the reader may press and hold down the sensor (right sensor or left sensor) for faster flipping of the pages. The rate of flipping (slow or fast) may be controlled by varying the pressure on the sensor (right sensor or left sensor), when held down. The number of pages flipped is determined by the amount of time the sensor (right sensor or left sensor) is pressed and held down.

In one example, sensors for page turning may be located anywhere along the edge of the electronic display 100 or on the screen 120. In another example, one or more sensors may also be located in the middle of the electronic display edges. One or more sensors may be included along the edges of the electronic display 100 from top to bottom or be located in the center for anywhere else in between along the edges of the electronic display 100.

In one example, the reader can advance multiple pages at a time by applying pressure (e.g., holding a thumb) at a desired point, for example, within the fore edge text block display and sharply turning the electronic display 100 on its side to approximately its perpendicular orientation in the direction of the page turned. As with a physical book, the rate of progression of the thumb or finger applying the pressure controls the speed of flipping.

In one example, the reader may recreate digitally the physical act of flipping pages through the written work presented on the screen 120 by tilting the electronic display 100 slightly to the left as with a physical book and/or pressing and holding the right side of the electronic display 100 with the digital view of the pages unopened. In this example, the left edge 130 (between “A” and “B”) and/or the right edge 140 (between “C” and “D”) of the electronic display 100 are equipped with one or more sensors to sense pressure applied to it by the reader. As with a physical book, the rate of progression of the thumb or finger applying the pressure controls the speed of flipping. In one example, the reader may stop quickly, review any interesting page, photographs or illustrations with the thumb/finger ceasing to apply pressure, and then continue on with applying pressure once the reader decides to start flipping pages again. The digital flipping of pages may be done either by using the left thumb on the text block (fore edge) display or by clicking and holding the sensor (e.g., S_{LH}, S_{RH}, left edge 130 or right edge 140) down. In one example, the curvature of a physical book is recreated digitally when the reader attempts to flip or turn pages entirely by the extent of the tightly controlled brushing or movement of the reader's thumb along the fore edge text block of the written work presented on the screen 120.

In one example, with the left thumb, the reader presses and holds about one inch from the left side of screen (either at top or bottom), for approximately one second. Then, the reader slowly slides the left thumb towards the left, and as it is sliding, the screen 120 will show pages being fanned to the right, until the thumb reaches the edge of screen. While the pages are being fanned, the reader may see a three dimensional animation of the actual pages being flipped. At any point in time the reader may release the left thumb, which will stop the flipping at that page.

In one example, with right thumb, the reader presses and holds about one inch from the right side of screen (either at top or bottom), for approximately one second. Then, the reader slowly slides the right thumb towards the right, and as it is sliding, the screen 120 will show pages being fanned to the left, until the right thumb reaches the edge of screen. While the pages are being fanned, the reader may see a three dimensional animation of the actual pages being flipped. At any point in time the reader may release the right thumb, which will stop the flipping at that page.

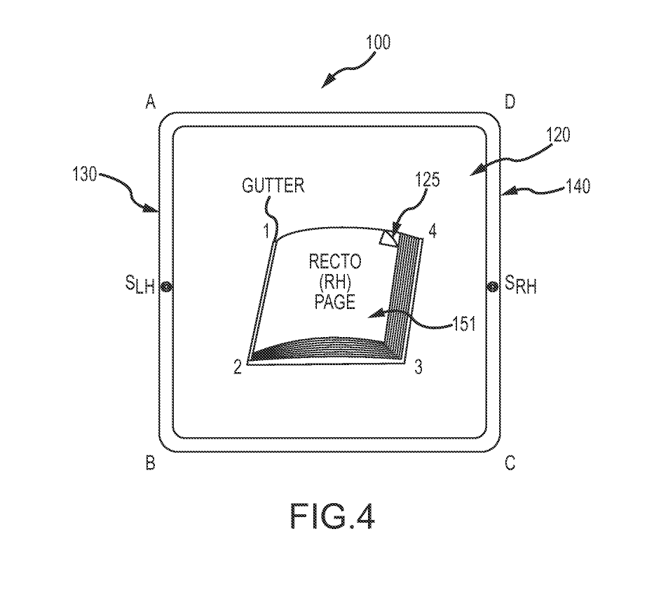

In one aspect, in the perspective view of the book with its pages recreated screen 120 on the electronic display 100, the reader may select where or which dog eared page to open with a finger on the screen 120. For example, the reader may “dog ear” a page by replicating the physical act of trying to fold the edge of the page by applying pressure on one of the corners (“A”, “B”, “C” or “D”). The corresponding page position of the written work 150 as it is displayed on the screen 120 will be dog eared accordingly. FIG. 4 illustrates an example of a single page of a written work being dog eared. In FIG. 4, each of the four corners “A”, “B”, “C” and “D” of the electronic display 100 includes a respective corner sensor (i.e., corner sensor A, corner sensor B, corner sensor C and corner sensor D). In the example of FIG. 4, if corner sensor A is held down, corner 1 of the page 151 is dog eared. If corner sensor B is held down, corner 2 of the page 151 is dog eared. If corner sensor C is held down, corner 3 of the page 151 is dog eared. If corner sensor D is held down, corner 4 of the page 151 is dog eared.

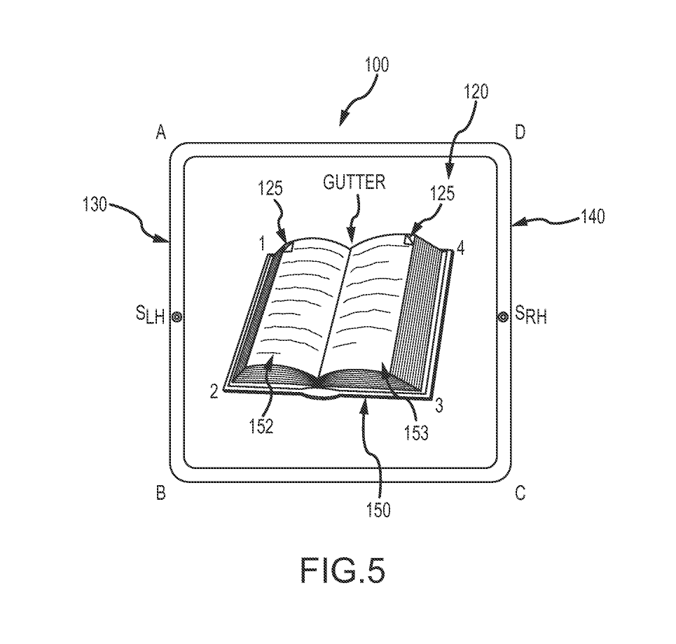

FIG. 5 illustrates an example of a 2-page view of a written work being dog eared. In FIG. 5, each of the four corners “A”, “B”, “C” and “D” of the electronic display 100 includes a respective corner sensor (i.e., corner sensor A, corner sensor B, corner sensor C and corner sensor D). In the example of FIG. 5, the verso (LH) page has two corners and the recto (RH) page has two corners. If corner sensor A is held down, corner 1 of the page 152 is dog eared. If corner sensor B is held down, corner 2 of the page 152 is dog eared. If corner sensor C is held down, corner 3 of the page 153 is dog eared. If corner sensor D is held down, corner 4 of the page 153 is dog eared.

In one aspect of the example in FIGS. 4 and 5, tugging on the underside of a corner sensor will also replicate the physical act of dog earing a page at the respective corner as discussed with respect to FIGS. 4 and 5, and the dog ear 125 will be visually be displayed on the page until removed. Once a page is dog eared at a particular corner, a tugging on the top/upper side of the respective corner sensor where the page is dog eared will remove the dog ear 125 on that corner of that page. In one example, more than one corner of a page may be dog eared.

In one aspect, the electronic display includes one or more sensors embedded in one or more of the following: an edge on the electronic display and/or the screen. In one example, the sensors sense thumb or figure pressure to flip a page or pages of the written work. One or more of the sensors may include an initial tactile click built in to prevent accidental turning of pages when pressure is applied. One or more sensors may be located along either edge (left edge or right edge, or even top edge or bottom edge) of the electronic display 100. One or more of the sensors may be clickable. In one example, one or more sensors may sense varying pressures and length of time it is being held down. In one example, the screen 120 of the electronic display may include one or more sensors embedded within and at locations of the screen where the text blocks may be displayed.

In one example, one or more sensors may sense how much orientation of the electronic display 100 has changed from a reference plane (e.g., a zero plane). In one example, one or more sensors may sense orientation of the electronic display 100 in the X, Y and Z-axis with respect to a starting point and with respect to the reader. In one example, the electronic display 100 may use information from one or more sensors for recreating a visual three dimensional (3D) presentation of an analog printed written work (e.g., book). In one example, as the reader incrementally turns the electronic display 100, the 3D view of the written work changes on the screen 120 replicating the reader's experience of holding and reading a physical written work (e.g., book).

In one example, while flipping or turning pages, the reader would see the display of the dog ears 125 and any annotations made on the pages as they are being flipped.

In one aspect, the reader may use native annotations made available on the electronic display 100. For example, a stylist pen 170 (not shown) may be applied to the screen 120 to annotate page being presented on the screen 120. In another example, text may be entered by the reader (e.g., via an associated keyboard 180) as annotations to be associated to page presented on the screen 120.

In one aspect, a sharp rapid rotation or tilt of the device in either direction close to or past perpendicular to the electronic display's orientation will close the written work 150 being presented on the screen 120. Once the written work 150 is closed, the screen 120 will display either the front cover or the back cover of the written work 150 depending on the direction of the sharp tilt applied. In one example, a sharp rapid flip of the electronic display 100 on the Y-axis or somewhere close to it will close the written work 150 (e.g., book) in the direction of the flip. Depending on the direction of the sharp flip, the display of the written work will show the front or back cover of the written work.

Although some of the examples present herein may refer or imply a physical or hardcopy book, one skilled in the art would understand that the present disclosure is equally applicable to any written work or to any written text that could be presented in physical or hardcopy book format.

In one aspect, additional features of the present disclosure may include providing an ability to rapidly flip through pages as a reader would in a physical book and be able to stop at any page and go back to an interesting page or photo or illustration that might have just whizzed by and tag and mark the page or pages for future quick review. Another feature is the ability to indicate where and how far the reader is within a written work (e.g., a book) by digitally recreating “a physical bookmark” within the pages of the written work at the start of the reading or review session. And, the reader is able to visualize the number and the extent of “dog eared” or annotated pages within the written work at any point in time. Still, another feature is to speed up review of search results using the cognitive pattern recognition anchored around dates as an example. In one aspect, cognitive pattern recognition is based on prior cognitive knowledge. For example, recognition is based on a collective memory about the content of the written work. In another example, recognition is based on cognitive intelligence. For example, a particular section of the context may not be familiar to the reader, however aspects of the written work are known to the reader. Thus, the known aspects are used by the reader to aid in the review of search results. In one aspect, an objective is to recreate the “look and feel” of a physical book in the reader's hands with a digital written work on the electronic display 100.

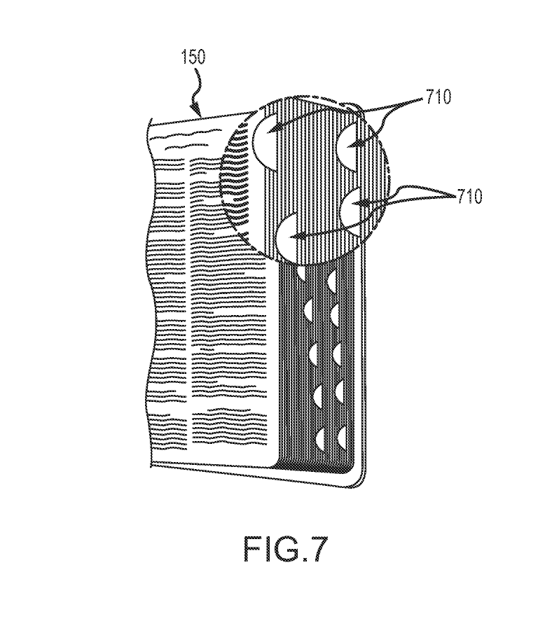

FIG. 7 illustrates an example of a written work 150 with thumb index 710. In one aspect, when tilting the electronic display 100 on its side, a thumb index 710 (also called a cut-in index), which in one example is a round cut-out as in the pages of dictionaries, encyclopedias, or other sectioned, often alphabetic reference works like Bibles, is used to locate entries starting at a particular letter or section. The thumb index 710 allows the reader to press a finger in the individual thumb index 710 and swipe, opening to that section. If the reader is unsure of which section a particular thumb cut represents, the reader may hold his finger for approximately one second, and a popup label will display the title of that section.

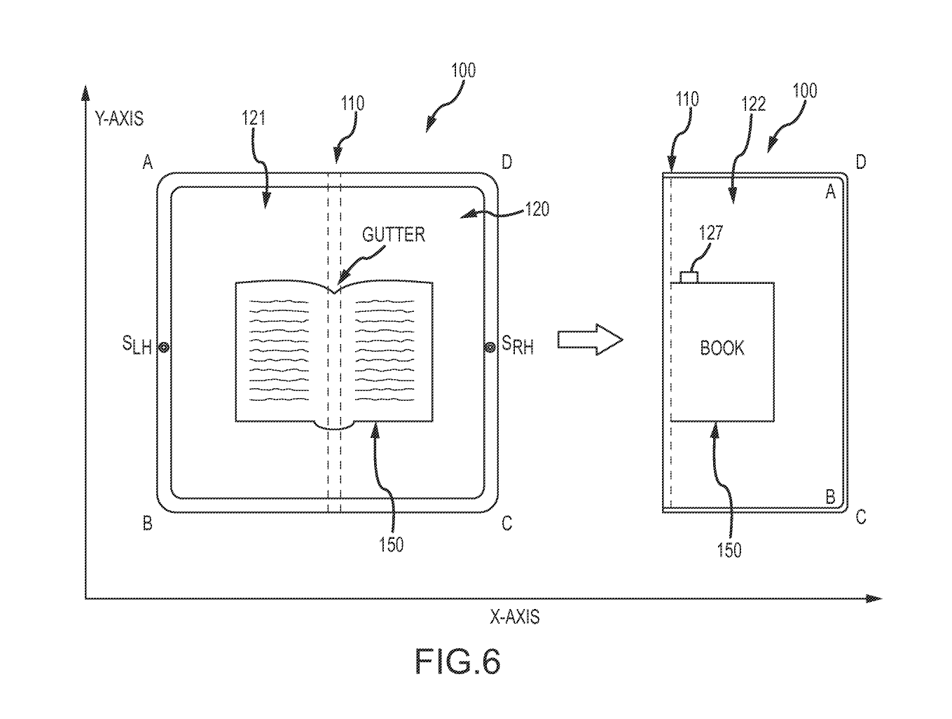

In one aspect, the electronic display is a flexible foldable device. FIG. 6 illustrates an example of an electronic display 100 with a hinge 110. For example, the electronic display 100 may include a hinge 110 to enable it to fold (for example, in the middle) for storage just as with a physical book. In the example of the flexible foldable electronic display, the reader may mimic the actual turning from one side of the written work (e.g., book) to the other side by rotating the electronic display 100 along its Y axis as one would with a physical book. With the flexible foldable feature, the reader may see and experience the natural curvature of the display of the adjacent page, which would adjust to reflect the display portion on the primary page. As the reader rotates the written work (e.g., book) on the x-axis towards oneself, the reader would see the display change to a perspective of viewing the written work slightly from the top of the written work.

In one example, the flexible foldable electronic display include multiple screens, at least one on the inner surface 121 and at least one on the outer surface 122, where the inner surface 121 and outer surface 122 share the same edges (e.g., left edge 130 and right edge 140) of the electronic display 100 and are 180 degrees opposed each other in one configuration. Display of the front and back covers of the written work (e.g., book) may occur on either side of a flexible foldable electronic display, either on the inside or on the outside display screens of the flexible foldable electronic display.

The present disclosure assumes that the written work is read from left to right. Similar concepts will apply to written work read right to left or top to bottom or vice versa. Although some activities described and elaborated herein may use only the analog elements of opening and reading a physical book, any additional digital approaches to performing some of these tasks are not excluded from the spirit and scope of the implementation within an electronic display for reviewing and/or reading a written work.

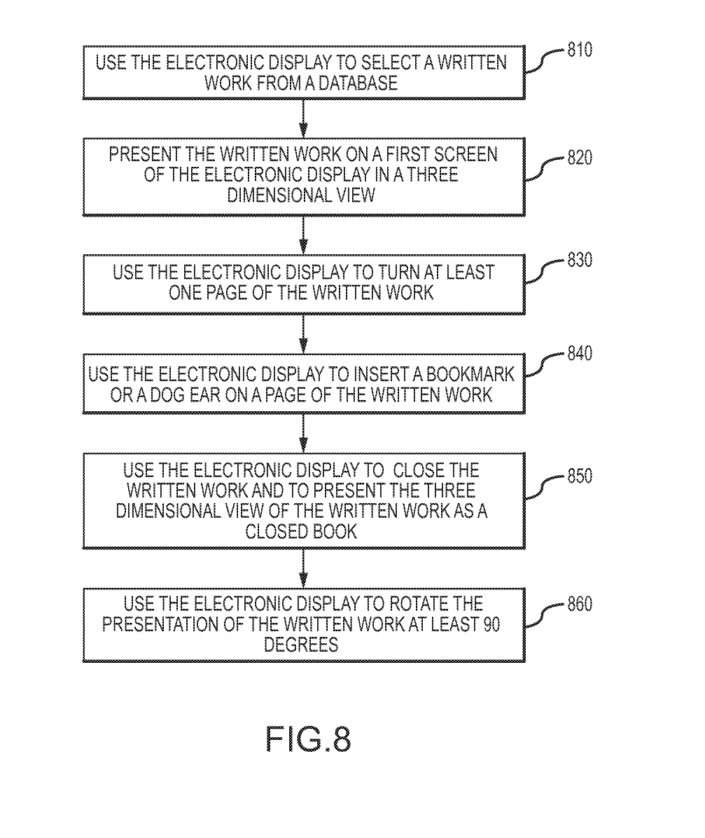

FIG. 8 illustrates an example of a flow diagram for displaying a written work on an electronic display. In block 810, use the electronic display to select a written work from a database. In block 820, present the written work on a first screen of the electronic display in a three dimensional view. In block 830, use the electronic display to turn at least one page of the written work. In one aspect, the written work is presented as a book. In block 840, use the electronic display to insert a bookmark 127 or a dog ear 125 on a page of the written work. In one example, more than one bookmark 127 and/or more than one dog ear 125 may be inserted to the page or pages of the written work. In one example, a bookmark 127 may be inserted by tapping a sensor located at or near the gutter of the written book 150. In one example, as the written work 150 is being closed, a bookmark 127 is added to the last page of the written work 150 that was presented on the screen 120. In another example, if a page of the written work 150 presented on the electronic display 100 has not been turned in a predetermined amount of time, a bookmark 127 is added to that page that has been presented for the predetermined amount of time. In another example, tugging and prolonged holding of the underside of the top or bottom of the electronic display 100 will replicate the physical act of inserting a bookmark 127.

In block 850, use the electronic display to close the written work and to present the three dimensional view of the written work as a closed book. In one aspect, the three dimensional view of the written work is presented on a second screen which is 180 degrees opposed the first screen. In block 860, use the electronic display to rotate the presentation of the written work at least 90 degrees.

In one aspect, the electronic display 100 includes a processor, a memory and at least one sensor working in conjunction to present and allow manipulation of text, photos, illustrations, or combinations thereof etc. on an electronic screen. Additionally, the electronic display 100 may include Internet input and output for communication with external databases. The electronic display 100 may include functional blocks that can represent functions implemented by a processor, software, hardware or combination thereof (e.g., firmware).

And, in one aspect, the electronic display 100 may include a transceiver module associated and/or working in conjunction with the Internet input and output to communicate with the external databases. A stand-alone receiver and/or stand-alone transmitter may be used in lieu of or in conjunction with transceiver module. In further related aspects, the electronic display 100 may optionally include a module for storing information, such as, for example, a memory module. The memory module may include a computer readable medium and may be operatively coupled to the other components of electronic display 100 via a bus or the like. The memory module may be adapted to store computer readable codes, instructions and/or data for effecting the processes and behavior of electrical components and subcomponents thereof, or processor, or the methods disclosed herein. Memory module may retain codes/instructions for executing functions associated with electrical components for implementing review, reading and 3D presentation of a written work on the screen of the electronic display. The electrical components may exist within or external to the memory module.

One skilled in the art would understand that the steps illustrated in the present disclosure may be interchanged in their order without departing from the scope and spirit of the present disclosure. Also, one skilled in the art would understand that the steps illustrated herein are not exclusive and other steps may be included or one or more of the illustrated steps may be deleted without affecting the scope and spirit of the present disclosure.

Those of skill would further appreciate that the various illustrative components, logical blocks, modules, circuits, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processor may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory and executed by a processor. Additionally, the various illustrative flow diagrams, logical blocks, modules and/or algorithm steps described herein may also be coded as computer-readable instructions carried on any computer-readable medium known in the art or implemented in any computer program product known in the art. In one aspect, the computer-readable medium includes non-transitory computer-readable medium.

In one or more examples, the steps or functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a processor (such as the processor in an electronic display) or a computer. By way of example, and not limitation, such computer-readable media may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. An electronic display comprising:
a left edge and a right edge;
a first screen situated between the left edge and the right edge, the first screen for presenting a written work in a three dimensional view;
a first sensor embedded on the left edge, and a second sensor embedded on the right edge, wherein the first sensor is for turning electronic pages of the written work towards the left edge and the second sensor is for turning electronic pages of the written work towards the right edge.

2. The electronic display of claim 1 further comprising a top edge and a bottom edge, wherein the top edge meets the left edge and the right edge, and the bottom edge meets the left edge and the right edge to define a rectangular dimension.

3. The electronic display of claim 2, wherein the first screen is situated between the top edge and the bottom edge.

4. The electronic display of claim 2 further comprising a first corner sensor situated at a first corner where the left edge meets the top edge, and a second corner sensor situated at a second corner where the right edge meets the top edge.

5. The electronic display of claim 4, wherein the first corner sensor and the second corner sensor are for marking dog-ears on respective corners of the written work.

6. The electronic display of claim 2 further comprising a corner sensor situated at a corner where the left edge meets the top edge.

7. The electronic display of claim 6, wherein the corner sensor is for marking a dog-ear on a corner of the written work.

8. The electronic display of claim 2 further comprising a corner sensor situated at a corner where the right edge meets the top edge.

9. The electronic display of claim 8, wherein the corner sensor is for marking a dog-ear on a corner of the written work.

10. The electronic display of claim 1 further comprising an orientation sensor for sensing orientation change of the electronic display.

11. The electronic display of claim 10 further comprising a processor for presenting the written work on the first screen, wherein the orientation change of the electronic display is inputted into the processor to respectively change the three dimensional view of the written work.

12. The electronic display of claim 1 further comprising a hinge along an axis for folding the electronic display along the axis.

13. The electronic display of claim 12, wherein the written work is presented on a second screen which is 180 degrees opposed the first screen.

14. The electronic display of claim 13, wherein the written work is presented as a closed book on the second screen.

15. The method of displaying a written work on an electronic display comprising:
using the electronic display to select a written work from a database;
presenting the written work on a first screen of the electronic display in a three dimensional view; and
using the electronic display to turn at least one page of the written work.

16. The method of claim 15, wherein the written work is presented as a book.

17. The method of claim 16 further comprising using the electronic display to insert a bookmark or a dog ear on a page of the written work.

18. The method of claim 16 further comprising using the electronic display to close the written work and to present the three dimensional view of the written work as a closed book.

19. The method of claim 18, wherein the three dimensional view of the written work is presented on a second screen which is 180 degrees opposed the first screen.

20. The method of claim 15 further comprising using the electronic display to rotate the presentation of the written work at least 90 degrees.
